(19) United States
(12) Patent Application Publication
(10) Pub. No.: US 2026/0006685 A1
(43) Pub. Date: Jan. 1, 2026

(54) GLAZING FOR A PLURALITY OF SENSORS, METHOD FOR MANUFACTURING THE SAME AND USE THEREOF

(71) Applicant: Pilkington Group Limited, Ormskirk, Lancashire (GB)

(72) Inventors: Joseph Jeremy BOOTE, Ormskirk, Lancashire (GB); Alastair FRENCH, Merseyside (GB)

(73) Assignee: Pilkington Group Limited, Ormskirk, Lancashire (GB)

(21) Appl. No.: 18/878,421

(22) PCT Filed: Jun. 15, 2023
(86) PCT No.: PCT/GB2023/051570

§ 371 Date: Dec. 23, 2024

(30) Foreign Application Priority Data
Jun. 24, 2022 (GB) 2209304.1

(51) Int. Cl. H05B 3/28; H05B 3/86

(52) U.S. Cl. CPC H05B 3/283; H05B 3/86; H05B 2203/008; H05B 2203/013

(57) ABSTRACT

A glazing for plural sensors, comprising a glass sheet, a conductive coating on part of the glass sheet surface, first and second busbars providing voltage to the conductive coating, a permeable area between the first busbar and part of the conductive coating, auxiliary busbars at an edge of the permeable area and in electrical contact with the conductive coating, and at least one supply line in the permeable area connecting at least one auxiliary busbar to the first busbar. A lower auxiliary busbar of the auxiliary busbars is at a lower edge of the permeable area. The permeable area has an asymmetric shape, comprising an imaginary symmetrical region and a protrusion) protruding from a side edge of the imaginary symmetrical region, and at least one side auxiliary busbar of the auxiliary busbars is at a part of the side edge of the imaginary symmetrical region lower than the protrusion.

### FIELD OF THE INVENTION

The invention is a glazing for a plurality of sensors, a method for manufacturing the same and use of the same, for example, as a window for a vehicle.

### BACKGROUND OF THE INVENTION

Glazings for a plurality of sensors are known comprising a glass sheet and an electrically conductive coating for heating, defogging, or defrosting the glazing. The conductive coating is impermeable to electromagnetic radiation used by the sensors. The glazings also comprise permeable areas so that a suitable wavelength of electromagnetic radiation for each sensor can pass through. Sensors are aligned with permeable areas.

US20130213949A1 (Lisinski) describes a windshield with a heatable coating and two first electrodes (busbars) to distribute current. The windshield has a coating-free zone to enable radio data traffic for a sensor. A second electrode has a supply section connected to a busbar, a ring-shaped portion in the coating-free zone, and connection sections that protrude like teeth of a comb to the coating. The second electrode has electrical resistance that corresponds to the electrical resistance the conductive coating would have had in a surface area of the same size as the coating-free zone. Current density is said to be virtually homogeneous, and hotspots are avoided.

A need remains for an alternative glazing for a plurality of sensors, to achieve a predetermined heating distribution and to allow data traffic for the sensors.

### Objectives of the Invention

A first objective of the invention is to provide a glazing for a plurality of sensors having a conductive coating and a permeable area for the plurality of sensors. A second objective is to provide a method of manufacturing said glazing. A third objective is to provide said glazing for use as a window.

### SUMMARY OF THE INVENTION

In a first aspect, the present invention provides a glazing for a plurality of sensors, the glazing comprising the features of claim 1.

The invention provides a glazing for a plurality of sensors, comprising: a glass sheet, a conductive coating on part of a surface of the glass sheet, first and second busbars for providing a voltage to the conductive coating, a permeable area arranged between the first busbar and part of the conductive coating, a plurality of auxiliary busbars at an edge of the permeable area and in electrical contact with the conductive coating, at least one supply line disposed at least partly in the permeable area and connecting at least one auxiliary busbar and the first busbar, and a lower auxiliary busbar is configured at a lower edge of the permeable area, wherein the permeable area has an asymmetric shape, comprising an imaginary symmetrical region and a protrusion protruding from part of a side edge of the imaginary symmetrical region, and wherein at least one side auxiliary busbar is configured at a part of the side edge of the imaginary symmetrical region lower than the protrusion.

Advantageously, a glazing having a permeable area with an asymmetric shape due to a protrusion and a side auxiliary busbar lower than the protrusion provides a surprisingly uniform heat distribution.

Prior art discloses a plurality of sensors each with a symmetrical coating-free area has non-uniform heat distribution. The inventors observed an asymmetric coating-free area having a side protrusion has an even less homogeneous heat distribution.

The invention surprisingly discloses that a side auxiliary busbar lower than the protrusion provides a homogeneous heat distribution. Unexpectedly, the invention configures a side auxiliary busbar away from the protrusion that causes non-uniform heat distribution, instead of at the same level.

Surprisingly, a method for manufacturing a glazing with a side auxiliary busbar at a side edge lower than the protrusion is simpler than the prior art.

A result of the invention is that the glazing meets industrial test requirements for defogging and defrosting of a vehicle window having a plurality of sensors. The invention meets requirements for a vehicle windshield in a camera system to enable an autonomous vehicle or a vehicle with an advanced driver assistance system.

Preferably, the protrusion partly forms an upper edge section of the permeable area adjacent the first busbar.

Preferably, the protrusion has a rectangular shape and a major axis parallel to the first busbar.

Preferably, the protrusion comprises a grid of deletion lines.

Preferably, at least one auxiliary busbar has a rectangular shape and a major axis substantially perpendicular to the major axis of the protrusion.

Preferably, at least two side auxiliary busbars are located at a part of the side edge of the imaginary symmetrical region. Advantageously, none of the plurality of auxiliary busbars overlaps the protrusion.

Preferably, the glazing comprises at least three auxiliary busbars.

Preferably, at least one interconnecting supply line connects any two auxiliary busbars.

Preferably, the glazing comprises at least two interconnecting supply lines.

Preferably, the glazing further comprises a printed area forming a frame shaped circumferential masking strip obscuring the first busbar and extending from the first busbar at least to an edge of the permeable area.

Preferably, the glazing comprises a coated printed section of the printed area covered by a part of the conductive coating adjacent an edge of the permeable area.

Preferably, the glazing comprises at least a hole in the printed area for a sensor.

Preferably, the glass sheet is bonded to another glass sheet by a ply of interlayer material to form a laminated glass wherein one of the glass sheets is an inner glass sheet for facing the plurality of sensors.

Preferably, a power density of the conductive coating between first and second busbars is in a range from 100 to 3,000 W/m², more preferably from 200 to 1,000 W/m², most preferably from 300 to 600 W/m².

Preferably, resistances of the least one supply line, and resistances of the at least one interconnecting supply line, and sheet resistance of the conductive coating, and positions of the first and second busbars, and positions of the auxiliary busbars are configured such that a voltage of 14 volts applied to first and second busbars causes a voltage drop between the first busbar and each of the auxiliary busbars in a range from 0.8 to 3.3 volts. For an applied voltage of 48 volts, voltage drop range is from 2.7 to 11.3 volts. For other applied voltages, voltage drop range is in the same proportion.

In a second aspect, the present invention provides a method for manufacturing a glazing comprising the steps of providing a glass sheet, depositing a conductive coating on a surface of the glass sheet, forming first and second busbars on the conductive coating for providing a voltage thereto, arranging a permeable area of the glass sheet between the first busbar and part of the conductive coating, configuring a plurality of auxiliary busbars at an edge of the permeable area and in electrical contact with the conductive coating, configuring at least one supply line in the permeable area connecting at least one auxiliary busbar and the first busbar, configuring a lower auxiliary busbar of the plurality of auxiliary busbars at a lower edge of the permeable area and the steps of configuring the permeable area to have an asymmetric shape, comprising an imaginary symmetrical region and a protrusion protruding from part of a side edge of the imaginary symmetrical region, and wherein at least one side auxiliary busbar is configured at a part of the side edge of the imaginary symmetrical region lower than the protrusion.

Preferably, the step of depositing a conductive coating is preceded by a step of configuring a printed area forming a frame-shaped circumferential masking strip to obscure the first busbar and extending from the first busbar at least to an edge of the permeable area, optionally so that the glazing comprises a coated printed section of the printed area covered by a part of the conductive coating adjacent an edge of the permeable area.

Preferably, the method comprises bonding the glass sheet to another glass sheet by a ply of interlayer material to form a laminated glass wherein one of the glass sheets is an inner glass sheet for facing the plurality of sensors.

In a third aspect, the present invention provides use of the glazing according to claim 1 as a windshield, a rear window, a side window, or a roof window of a motor vehicle, for a sensor system to enable an autonomous vehicle or a vehicle with an advanced driver assistance system.

The invention will now be disclosed by non-limiting drawings and examples.

### BRIEF DESCRIPTION OF THE DRAWINGS

FIG. 1 is an embodiment of the invention having a protrusion (dotted area) from an imaginary symmetrical region (rest of asymmetric area bounded by dashed line).

FIG. 2 is a cross-section on the line A-A of FIG. 1.

FIG. 3 is an embodiment of the invention having an interconnecting supply line.

FIG. 4 is an embodiment of the invention having three auxiliary busbars.

FIG. 5 is an embodiment of the invention having three auxiliary busbars and an interconnecting supply line.

FIG. 6 is an embodiment of the invention having three auxiliary busbars and two interconnecting supply lines.

FIG. 7 is an embodiment of the invention having a printed coated area.

FIG. 8 is a cross-section on the line of A-A of FIG. 7.

FIG. 9 is an embodiment of the invention having a printed coated area and one interconnecting supply line.

FIG. 10 is an embodiment of the invention having a printed coated area and two interconnecting supply lines.

### DETAILED DESCRIPTION OF THE INVENTION

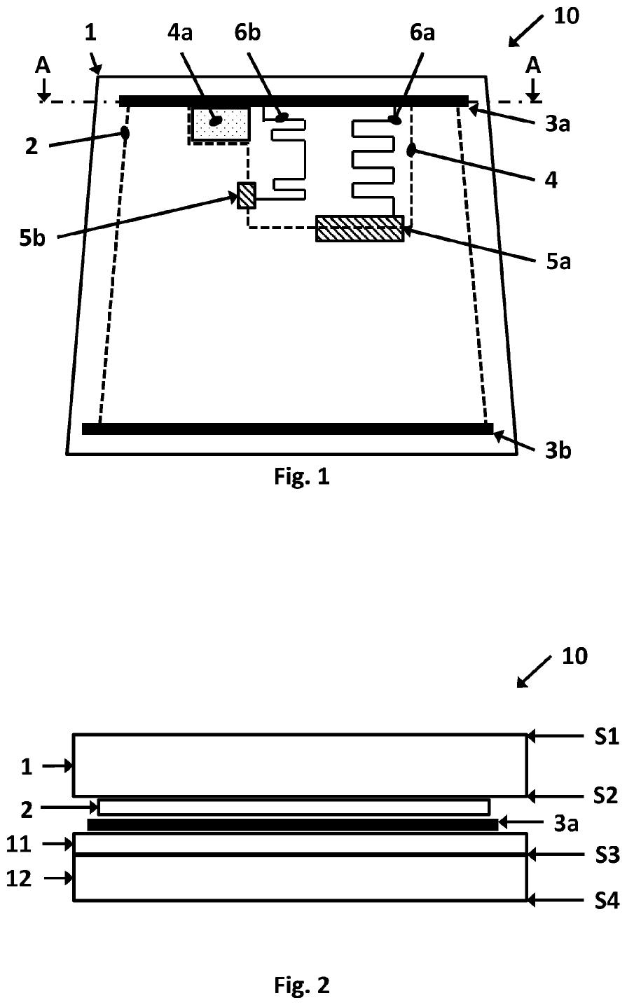

FIG. 1 discloses a glazing 10 for a plurality of sensors according to the invention comprising a glass sheet 1 and a conductive coating 2 deposited on a major part of the glass sheet 1. Boundary of the coated area 2 is shown as a dashed line.

A peripheral region of the glass sheet 1 is coating-free because the peripheral region was masked during deposition of the conductive coating 2, or edge deletion of the conductive coating 2 in the peripheral region. A coating-free peripheral region is useful for electrical insulation of the edge of the glazing 10 and to avoid chemical corrosion of the conductive coating 2 due to water ingress.

The conductive coating 2 is typically transparent. The conductive coating 2 may comprise two, three or four layers of silver, or a layer of a transparent conductive oxide (TCO), such as tin oxide, fluorine doped tin oxide, or indium tin oxide. Sheet resistance of the conductive coating 2 on the glass sheet 1 is typically in a range from 0.1 to 10 ohms/square, preferably 0.5 to 5 ohms/square, and more preferably 0.7 to 1.5 ohms/square. The conductive coating 2 may comprise three layers of silver and have thickness in a range from 237 to 277 nanometres.

First and second busbars 3a, 3b are configured in contact with the conductive coating 2, preferably at upper and lower edges respectively, for providing a voltage. First and second busbars 3a, 3b may be printed on the glass sheet 1 by silk screen printing or inkjet printing of a conductive ink. The conductive ink contains glass frit mixed with conductive particles, typically of silver. The glazing 10 with printed ink on it is baked at high temperature to form a conductive enamel, then cooled. Alternatively, first and second busbars 3a, 3b may be strips of conductive material, typically copper. First and second busbars 3a, 3b may be any shape, preferably rectangular, having low resistance so that substantially the same voltage is available along their lengths for unform heat distribution in the conductive coating 2. Ends of the first and second busbars 3a, 3b extend into the coating-free peripheral region to avoid hot spots at the edges of the conductive coating 2.

A permeable area 4 is arranged between the first busbar 3a and part of the conductive coating 2. The permeable area 4 may be masked during deposition of the conductive coating 2 resulting in a coating-free permeable area 4. Alternatively, or in addition, deletion of the conductive coating 2 may provide a permeable area 4 that is coating-free or partly coating-free. Coating deletion may be by any process, preferably mechanical abrasion, or laser ablation. The permeable area 4 enables a predetermined wavelength of electromagnetic radiation to pass through the glazing 10 to allow data traffic for a plurality of sensors. The permeable area 4 may comprise a grid pattern having a pitch suitable for the predetermined wavelength of electromagnetic radiation, and optionally configured as a protrusion 4a. The protrusion 4a may protrude from part of a side edge of an imaginary symmetrical region, such that the permeable area 4 is asymmetric. The imaginary symmetrical region may have any symmetrical shape, including U-shaped, semi-elliptical, semi-circular, triangular, or rectangular. The protrusion 4a may have any shape, including rectangular, and partly forms an upper edge section of the permeable area adjacent the first busbar 3a.

In FIG. 1, two auxiliary busbars 5a, 5b are configured at an edge of the permeable area 4 and in electrical contact with the conductive coating 2. A lower auxiliary busbar 5a is configured at a lower edge of the permeable area 4. Preferably the lower auxiliary busbar 5a is configured to include the lowest point of the permeable area 4.

In FIG. 1, two supply lines 6a, 6b are configured in the permeable area 4 connecting respectively the two auxiliary busbars 5a, 5b to the first busbar 3a. Electrical resistances of the supply lines 6a, 6b, sheet resistance of the conductive coating 2, positions of the first and second busbars 3a, 3b, and positions of the auxiliary busbars 5a, 5b are configured such that a voltage of 14 volts applied to first and second busbars 3a, 3b causes predetermined voltage drops between the first busbar 3a and each of the auxiliary busbars 5a, 5b. The predetermined voltage drops are in a range from 0.8 to 3.3 volts, preferably 0.9 to 3.13 volts.

The conductive coating 2 may have any heated surface area, such as in a range from 0.56 to 1.56 m², preferably from 0.76 to 1.36 m², more preferably from 0.86 to 1.16 m².

The conductive coating 2 may have any power density, such as in a range from 281 to 354 W/m², preferably from 291 to 344 W/m², more preferably from 301 to 334 W/m².

FIG. 2 is a cross-section on the line A-A of FIG. 1. In this embodiment, the glass sheet 1 is an outer glass sheet bonded by a ply of interlayer material 11 to an inner glass sheet 12. Alternatively, the glazing 10 can be configured such that the glass sheet 1 having the conductive coating 2 is the inner glass sheet. The glass sheets 1, 12 are preferably soda lime silica glass, manufactured using the float process. Glass thickness is preferably in a range from 2 to 12 mm. The glass sheets 1, 12 may be toughened glass with surface stress greater than 65 MPa, or heat strengthened glass with surface stress in a range from 40 to 55 MPa, or semi-toughened with surface stress in a range from 20 to 25 MPa, or annealed glass. The interlayer material 11 is any thermoplastic resin, preferably polyvinyl butyral (PVB).

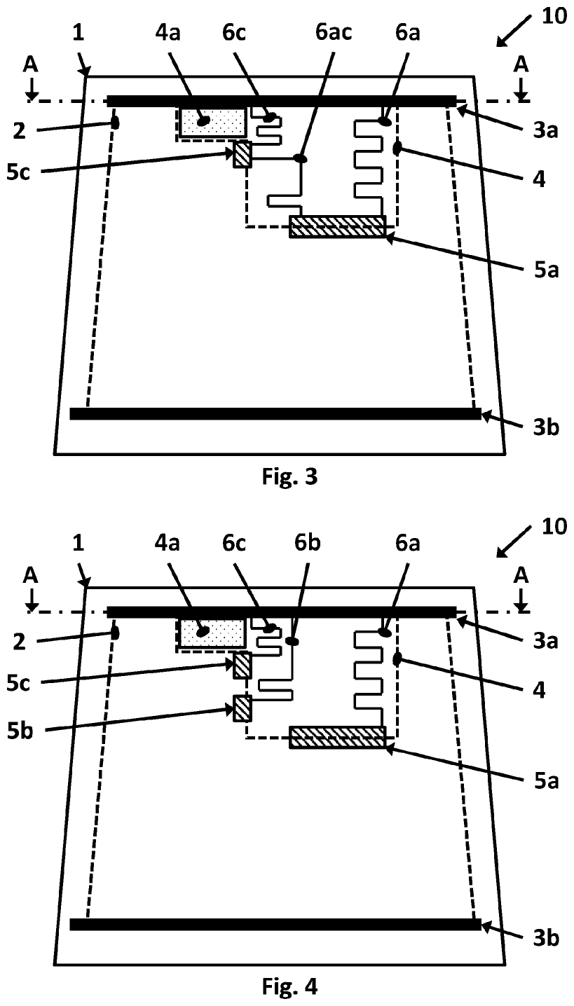

FIG. 3 discloses an embodiment of the invention similar to FIG. 1, further comprising an interconnecting supply line 6ac electrically connected between the lower auxiliary busbar 5a and the side auxiliary busbar 5c.

FIG. 4 discloses an embodiment of the invention similar to FIG. 1, further comprising second side auxiliary busbar 5b, configured between the lower auxiliary busbar 5a and the side auxiliary busbar 5c.

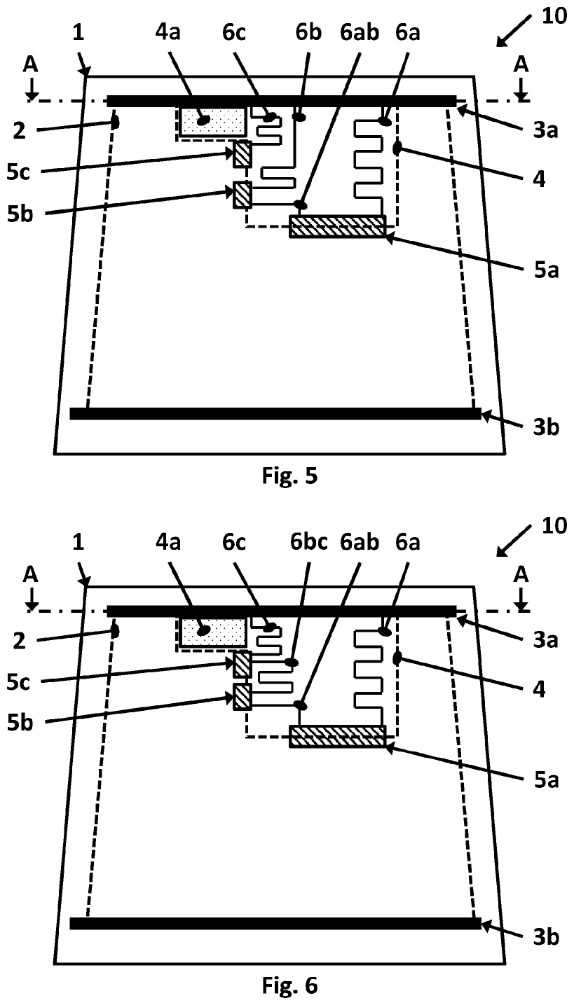

FIG. 5 discloses an embodiment of the invention similar to FIG. 4, further comprising an interconnecting supply line 6ab electrically connected between the lower auxiliary busbar 5a and the second side auxiliary busbar 5b.

FIG. 6 discloses an embodiment of the invention similar to FIG. 5, further comprising a second interconnecting supply line 6bc electrically connected between the second side auxiliary busbar 5b and the side auxiliary busbar 5c.

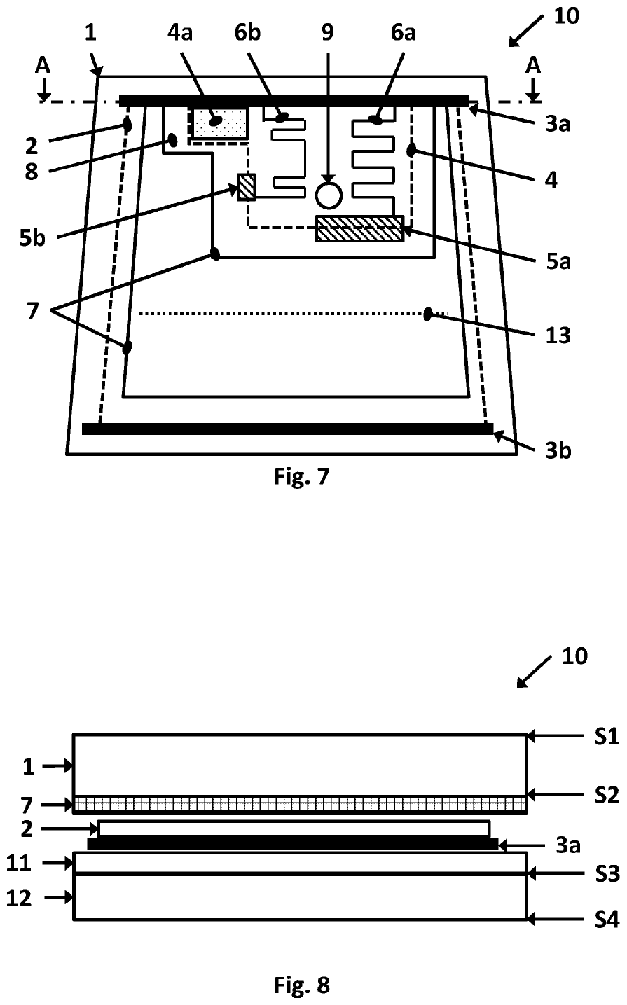

FIG. 7 discloses an embodiment of the invention similar to FIG. 1, further comprising a printed area 7 forming a frame shaped circumferential masking strip obscuring the first busbar 3a and extending from the first busbar 3a at least to an edge of the permeable area 4. Boundary of the printed area 7 is shown as a solid line.

Preferably, a part of the printed area 7 extends beyond the edge of the permeable area 4 and is covered by the conductive coating 2 to form a coated printed section 8. Sheet resistance of the coated printed section 8 is higher than that of the conductive coating 2 directly on the glass sheet 1. Typically, the sheet resistance of the coated printed section 8 is greater than or equal to double the sheet resistance of the conductive coating 2 directly on the glass sheet 1. Sheet resistance of the coated printed section 8 is typically in a range from 0.2 to 20 ohms/square, preferably 1.0 to 10 ohms/square, and more preferably 1.4 to 3.0 ohms/square.

The glazing 10 further comprises a hole 9 positioned in a part of the printed area 7 masking the permeable area 4. The hole 9 is for a sensor, such as a camera for visible or infrared wavelengths, so that the sensor is not masked by the printed area 7.

The glazing 10 further comprises a viewing area. The viewing area may be any shape. At least one imaginary temperature test line 13 at a predetermined distance between highest and lowest points of the viewing area. Preferably, temperature profile is controlled at three temperature test lines 13, namely bottom quartile, middle line, and top quartile. Preferably, the viewing area is bounded by the printed area 7.

FIG. 8 is a cross-section on the line A-A of FIG. 7. FIG. 8 discloses the printed area 7 is printed on an inner surface S2 of the glass sheet 1, shown as the outer glass sheet of a laminated glass 10. Alternatively, glass sheet 1 may be the inner glass sheet and printed area 7 is on a surface S3 of the laminated glass 10.

The printed area 7 may comprise a black enamel. The black enamel is deposited as black ink in a selected region on the glass sheet 1, preferably by screen printing. The glass sheet 1 is then baked at a predetermined temperature for a predetermined time to form a black enamel. Advantageously, the printed area 7 extends around a periphery of the glazing 10 to mask an adhesive material, such as polyurethane (PU), used to bond the glazing 10 to a vehicle body or a window frame (not shown).

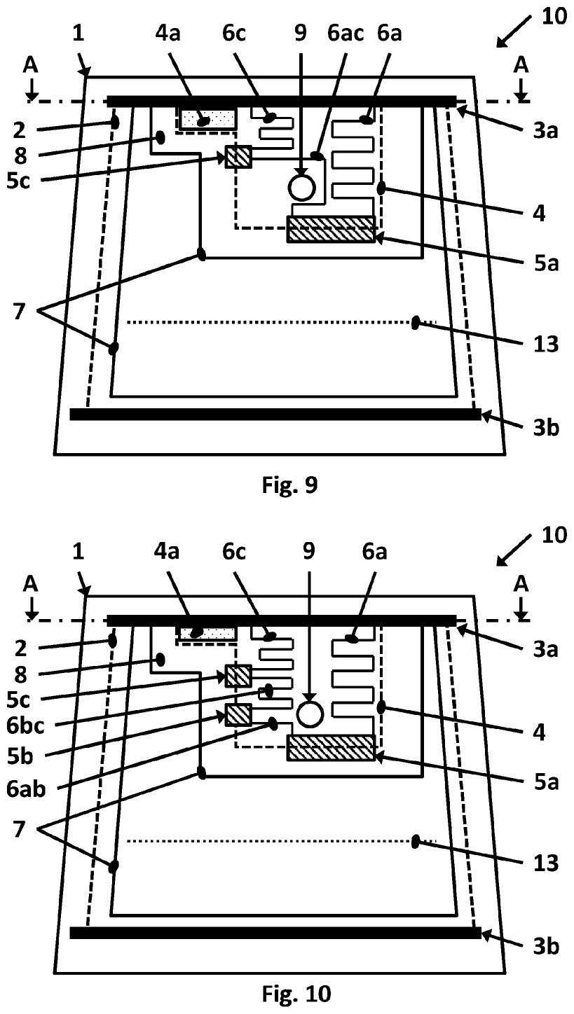

FIG. 9 discloses an embodiment of the invention similar to FIG. 7, further comprising an interconnecting line 6ac electrically connected between the lower auxiliary busbar 5a and the side auxiliary busbar 5c. Advantageously, interconnecting line 6ac is configured to have a path around the hole 9 for heating, defogging, or defrosting the hole 9, at the same time as achieving a predetermined voltage drop between the first busbar 3a and each of the auxiliary busbars 5a, 5c, thereby reducing hotspots in temperature profiles around the permeable area 4.

FIG. 10 discloses an embodiment of the invention similar to FIG. 9, further comprising a second side auxiliary busbar 6b and comprising two interconnecting supply lines 6ab, 6bc electrically connected between the lower auxiliary busbar 5a and the second side auxiliary busbar 5b, and between the second side auxiliary busbar 5b and the side auxiliary busbar 5c. Advantageously, the embodiments of FIG. 9 and FIG. 10 lack the supply line 6b shown in FIG. 7. The inventors have found that interconnecting supply lines 6ac (in FIG. 9) or 6ab and 6bc (in FIG. 10) provide advantageous heating, defogging, or defrosting of the hole 9, and at the same time achieve a predetermined voltage drop between the first busbar 3a and each of the auxiliary busbars 5a, 5c, thereby reducing hotspots in temperature profile lines 13.

The protrusion 4a is advantageous for a sensor such as a camera, an RFID tag, or any electronic device to transmit and receive electromagnetic radiation, such as visible light or radio frequencies. For example, vehicle windows allow data acquisition for toll collection, or for Advanced Driver Assistance Systems (ADAS) to assist drivers in driving and parking functions. The sensor is mounted on a bracket (not shown) aligned with the protrusion 4a, or directly on a surface S2 of the glass sheet 1, or on an inner surface S4 of the glazing 10. Advantageously, protrusion 4a is covered by the printed area 7 so the sensor is masked in the visible part of the electromagnetic spectrum, but data traffic is enabled at the predetermined wavelength of radio frequency.

### Examples

Table 1 discloses results of simulations of three examples of glazings 10 according to the invention, and one comparative example according to the prior art.

Imaginary temperature profile lines 13 were monitored at top quartile of a viewing area of the glazing 10, and at the auxiliary busbars 5a, 5b, 5c.

The comparative example has a lower auxiliary busbar 5a, but lacks side auxiliary busbars 5b, 5c configured on a part of a side edge of an imaginary symmetrical region, configured lower than a protrusion 4a. A hotspot occurred at the lower auxiliary busbar 5a at an unacceptable temperature 71.7° C.

Example 1 according to the invention in addition to lower auxiliary busbar 5a, further comprised side auxiliary busbar 5b. Side auxiliary busbar 5b was spaced away from the protrusion 4a, closer to the lower auxiliary busbar 5a than to the protrusion 4a. A warm spot occurred at the lower auxiliary busbar 5a, reaching 49.5° C.

Example 2 according to the invention in addition to lower auxiliary busbar 5a, further comprised side auxiliary busbar 5c configured on a part of a side edge of an imaginary symmetrical region, configured lower than a protrusion 4a, but as close as possible to the protrusion 4a. A warm spot occurred at the side auxiliary busbar 5c, reaching 59.8° C.

Example 3 according to the invention in addition to lower auxiliary busbar 5a, further comprised two side auxiliary busbars 5b, 5c. Side auxiliary busbar 5c was as close as possible to the protrusion 4a. Side auxiliary busbar 5b was spaced away from the protrusion 4a, closer to the lower auxiliary busbar 5a than to the protrusion 4a. A warm spot occurred at the side auxiliary busbar 5c, reaching 49.9° C.

TABLE 1
Auxiliary busbar temperature in ° C.

| | Auxiliary | 5a | 5b | 5c |
|---|---|---|---|---|
| | busbars | A | B | C |
| Comparative | A | 71.7 | None | None |
| Example 1 | A, B | 49.5 | 33.9 | None |
| Example 2 | A, C | 52.3 | None | 59.8 |
| Example 3 | A, B, C | 49.9 | <30 | 56.3 |

### KEY TO THE DRAWINGS

References in the drawings are as follows:
1—Glass sheet
2—Conductive coating
3a, 3b—Busbars
4—Permeable area
4a—Protrusion
5a, 5b, 5c—Auxiliary busbars
6a, 6b, 6c—Supply lines
6ab, 6ac, 6bc—Interconnecting supply lines
7—Printed area
8—Coated printed section of the printed area
9—Hole in printed area
10—Glazing
11—Ply of interlayer material
12—Another glass sheet
13—Temperature test line
S1—Surface 1
S2—Surface 2
S3—Surface 3
S4—Surface 4

1. A glazing for a plurality of sensors, comprising:
a glass sheet,
a conductive coating on part of a surface of the glass sheet,
first and second busbars for providing a voltage to the conductive coating,
a permeable area arranged between the first busbar and part of the conductive coating,
a plurality of auxiliary busbars at an edge of the permeable area and in electrical contact with the conductive coating,
at least one supply line configured in the permeable area connecting at least one auxiliary busbar to the first busbar,
a lower auxiliary busbar of the plurality of auxiliary busbars configured at a lower edge of the permeable area,
wherein:
the permeable area has an asymmetric shape, comprising an imaginary symmetrical region and a protrusion protruding from part of a side edge of the imaginary symmetrical region, and
at least one side auxiliary busbar of the plurality of auxiliary busbars is configured at a part of the side edge of the imaginary symmetrical region lower than the protrusion.

2. A glazing according to claim 1, wherein the protrusion partly forms an upper edge section of the permeable area adjacent the first busbar.

3. A glazing according to claim 1, wherein the protrusion has a rectangular shape and a major axis parallel to the first busbar.

4. A glazing according to claim 1, wherein the protrusion comprises a grid of deletion lines.

5. A glazing according to claim 1, wherein at least one auxiliary busbar has a rectangular shape and a major axis substantially perpendicular to the major axis of the protrusion.

6. A glazing according to claim 1, wherein none of the plurality of auxiliary busbars overlaps the protrusion.

7. A glazing according to claim 1, comprising at least three auxiliary busbars.

8. A glazing according to claim 1, further comprising at least one interconnecting supply line connecting any two auxiliary busbars.

9. A glazing according to claim 8, comprising at least two interconnecting supply lines each connecting any two auxiliary busbars.

10. A glazing according to ng-claim further comprising a printed area forming a frame shaped circumferential masking strip obscuring the first busbar and extending from the first busbar at least to an edge of the permeable area.

11. A glazing according to claim 10, further comprising a coated printed section of the printed area covered by a part of the conductive coating adjacent an edge of the permeable area.

12. A glazing according to claim 11, wherein a sheet resistance of the coated printed section is not more than double a sheet resistance of the conductive coating not on the printed area.

13. A glazing according to claim 1, comprising at least a hole in the printed area for a sensor.

14. A glazing according to claim 1, wherein the glass sheet is bonded to another glass sheet by a ply of interlayer material to form a laminated glass wherein one of the glass sheets is an inner glass sheet for facing the plurality of sensors.

15. A glazing according to claim 1, wherein power density in the conductive coating is in a range from 100 to 3000 W/m².

16. A glazing according to claim 1, wherein the resistances of the least one supply line and the resistances of the at least one interconnecting supply line and the sheet resistance of the conductive coating and the positions of the first and second busbars and the positions of the auxiliary busbars are configured such that a voltage of 14 volts applied to first and second busbars causes a voltage drop between the first busbar and each of the auxiliary busbars in a range from 0.8 to 3.3 volts.

17. A method for manufacturing a glazing for a plurality of sensors according to claim 1, comprising:
providing a glass sheet,
depositing a conductive coating on a surface of the glass sheet,
forming first and second busbars on the conductive coating for providing a voltage thereto,
arranging a permeable area of the glass sheet between the first busbar and part of the conductive coating,
configuring a plurality of auxiliary busbars at an edge of the permeable area and in electrical contact with the conductive coating,
configuring at least one supply line in the permeable area and connecting at least one auxiliary busbar to the first busbar,
configuring a lower auxiliary busbar at a lower edge of the permeable area,
configuring the permeable area to have an asymmetric shape, comprising an imaginary symmetrical region and a protrusion from part of a side edge of the imaginary symmetrical region, and
configuring at least one side auxiliary busbar of the plurality of auxiliary busbars at a part of the side edge of the imaginary symmetrical region lower than the protrusion.

18. A method for manufacturing a glazing according to claim 17, wherein the step of depositing a conductive coating is preceded by a step of configuring a printed area forming a frame-shaped circumferential masking strip to obscure at least the first busbar and extending from the first busbar at least to an edge of the permeable area.

19. A method for manufacturing a glazing according to claim 17, further comprising a step of bonding the glass sheet to another glass sheet by a ply of interlayer material to form a laminated glass wherein one of the glass sheets is an inner glass sheet for facing the plurality of sensors.

20. Use of the glazing according to claim 1 as a windshield, a rear window, a side window, or a roof window of a motor vehicle for a sensor system to enable an autonomous vehicle or a vehicle with an advanced driver assistance system.
